(19) United States
(12) Patent Application Publication
(10) Pub. No.: US 2005/0057485 A1
(43) Pub. Date: Mar. 17, 2005

(54) Image color transformation to compensate for register saturation

(76) Inventor: Paul S. Diefenbaugh, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/664,013

(22) Filed: Sep. 15, 2003

(51) Int. Cl. G09G 3/36

(52) U.S. Cl. 345/102

(57) ABSTRACT

Dynamically brightening the color of a displayed image through modifications to a graphics color look-up table with a corresponding decrease in backlight intensity can results in a displayed image that is comparable in quality to the original image. An image brightness histogram can be used to detect and respond to meaningful changes in the displayed image. The brightness histogram uses a set of hardware registers to store a number pixels in the image corresponding to various brightness values. Under certain conditions the number of pixels in an image can exceed the number that can be stored in a register, one or more registers may fail to provide a proper indication of the number of pixels that correspond to a particular brightness causing register saturation. Excess pixel data is reassigned to neighboring registers until the previously saturated register is no longer saturated.

### TECHNICAL FIELD

The invention relates to image control. More particularly the invention relates to adjustment of image intensity compensation in response to register saturation.

### BACKGROUND

Because batteries provide power to operate a laptop computer or other portable electronic device for a limited period of time, a need exists to efficiently use the power available to provide the longest possible operating period. This need has resulted in various power saving techniques such as, for example, shutting down or reducing power in components that are not being heavily used, or where policy is to prefer power savings over performance.

One component that can have it's power reduced during periods of inactivity or when power conservation is preferred is the LCD panel and backlight. In a typical laptop computer, for example, the display can consume 30% or more of the power consumed by the system. In order to reduce display power consumption, some laptop computer systems reduce the panel backlighting when in battery-powered mode. However, because LCDs are transmissive display devices (i.e., LCDs depend on the quantity and quality of the backlight source for producing the perceived color gamut), reduction of backlight brightness alone results in an image that the user often perceives as of lower quality than the same image with a brighter backlighting.

Display image quality is further effected by ambient light surrounding the display, which can reduce the environments in which a user may feel comfortable using a battery powered device that adjusts the backlight to save power, which is especially important considering the self-contained battery power-source is one of the key factors facilitating mobility that allows the use to move at will between different indoor and outdoor environments.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of an electronic system.

FIG. 2 illustrates a cross-section of one embodiment of a flat-panel display monitor.

FIG. 3 illustrates a group of pixels within a flat-panel monitor screen.

FIG. 4 illustrates one embodiment of a light emitting diode (LED) backlight for a notebook computer display system.

FIG. 5 illustrates one embodiment of a display system.

FIG. 6 is a conceptual illustration of a histogram in which a brightness value causes register saturation.

FIG. 7 is a conceptual illustration of the histogram of FIG. 6 in which excess pixel data has been reassigned to a neighboring non-saturated register.

FIG. 8 is a conceptual illustration of the histogram of FIG. 7 in which excess pixel data has been reassigned to a neighboring non-saturated register.

FIG. 9 is a flow diagram of one embodiment of reassignment of excess pixel data.

### DETAILED DESCRIPTION

Methods and apparatuses for image color compensation are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

As described in greater detail below, backlight image adaptation (BIA) is a technique that can provide power savings by dynamically brightening the color of a displayed image through modifications to a graphics color look-up table with a corresponding decrease in backlight intensity. The image brightening with a corresponding decrease in backlight intensity results in a displayed image that is comparable in user-perceived brightness to the original image. In one embodiment, the BIA technique utilizes an image brightness histogram in order to detect and respond to meaningful changes in the displayed image. Alternatively, changes in image brightness can be detected without use of a histogram representation.

The brightness histogram, or other brightness monitoring technique, uses a set of hardware registers to store a number pixels in the image corresponding to various brightness values. That is, pixels are mapped to the registers based on computed brightness values. Because under certain conditions the number of pixels in an image can exceed the number that can be stored in a register, one or more registers may fail to provide a proper indication of the number of pixels that correspond to a particular brightness. This is referred to as “saturation” of the register.

Saturation can result be the result of one or more conditions. For example, brightness histograms (described in greater detail below) are generally computed using hardware for performance reasons. As display resolutions grow, the number of pixels displayed grows, which increases the possibility of register saturation. Registers are typically limited in size because registers are typically costly to provide. Increasing the size and/or number of registers increases die size, increases routing congestion and complexity, etc. For example, providing 256 32-bit registers for brightness histogram computation would solve register saturation problems, but currently would be cost prohibitive. Limiting the number of registers used for a brightness histogram leads to grouping of multiple brightness levels, which increases the probability of saturation.

Many common conditions exist where brightness registers become saturated. Many computer users spend significant amounts of time using office applications (e.g., word processing applications, spreadsheet applications) that typically require display of large numbers of white, black and or gray pixels. When a large number of pixels are white, for example, one or more registers corresponding to relatively high brightness values can become saturated.

In one embodiment, excess pixel data is reassigned to neighboring registers until the previously saturated register is no longer saturated. In one embodiment, excess pixel data is reassigned to an adjacent register corresponding to a lower brightness value. Excess pixel data can be reassigned to non-adjacent registers as well as registers corresponding to a higher brightness value.

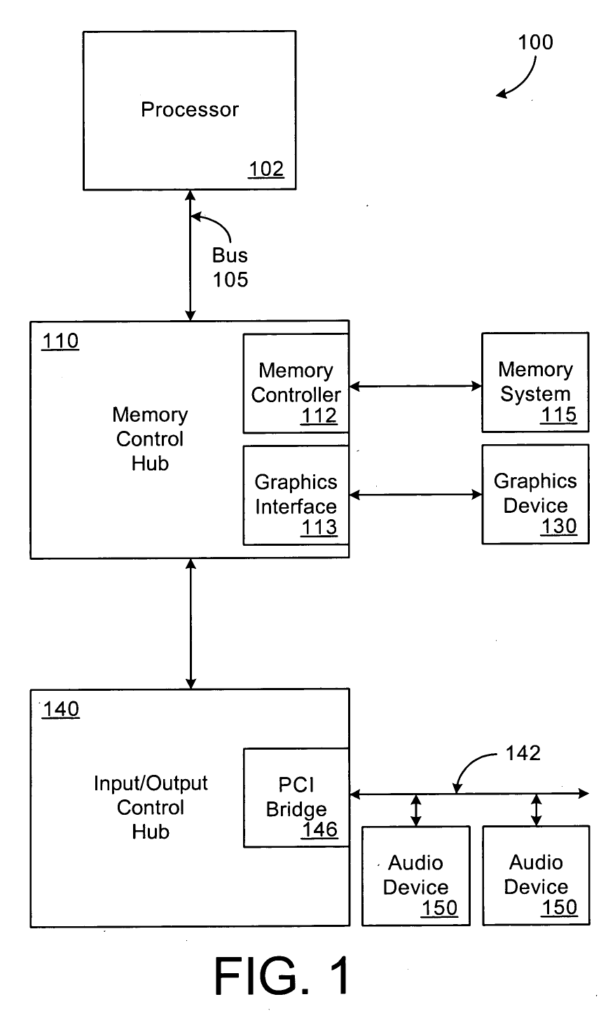

The image adaptation technique described herein can be applied to a broad class of electronic systems having associated display devices. While the examples herein a generally directed to laptop computers, the techniques described can be applied to personal digital assistants (PDAs), palm top computers, desktop computers using flat panel displays, kiosk displays, etc. FIG. 1 is a block diagram of one embodiment of an electronic system. Electronic system 100 includes processor 102 coupled to bus 105. In one embodiment, processor 102 is a processor in the Pentium® family of processors including the Pentium® II processor family, Pentium® III processors, Pentium® 4 processors, and Pentium-M processors available from Intel Corporation of Santa Clara, Calif. Alternatively, other and/or other processors may be used, such as Intel's StrongArm processor, XScale processor, ARM processors available from ARM Ltd. of Cambridge, the United Kingdom, or OMAP processor (an enhanced ARM-based processor) available from Texas Instruments, Inc., of Dallas, Tex.

Memory Control Hub (MCH) 110 is also coupled to the bus 105. MCH 110 may include memory controller 112 that is coupled to memory system 115. Memory system 115 stores data and sequences of instructions that are executed by processor 102 or any other device included in electronic system 100. In one embodiment, memory system 115 includes dynamic random access memory (DRAM); however, memory system 115 may be implemented using other memory types, for example, static random access memory (SRAM), or other configurations of integration, for example processor including memory controller. Additional devices not included in FIG. 1 may also be coupled to bus 105 and/or MCH 110.

MCH 110 may also include graphics interface 113 coupled to graphics device 130. In one embodiment, graphics interface 113 includes an accelerated graphics port (AGP) that operates according to an AGP Specification Revision 2.0 interface or PCI-Express Interface developed by Intel Corporation of Santa Clara, Calif. In another embodiment graphics device may be integrated with MCH forming a GMCH (Graphics and Memory Controller Hub). Other embodiments may be possible such as when MCH is integrated with the processor and Graphics Controller. In all cases Graphics Controller portion is referred to as Graphics Interface wherever contained therein.

In one embodiment, a flat panel display may be coupled to graphics interface 113 through, for example, a signal converter that translates a digital representation of an image stored in a storage device such as video memory or system memory into display signals that are interpreted and displayed by the flat-panel screen. Display signals produced by the display device may pass through various control devices before being interpreted by and subsequently displayed on the flat-panel display monitor. Other graphics interfaces and protocols can also be used.

MCH 110 is further coupled to input/output control hub (ICH) 140, which provides an interface to input/output (I/O) devices. ICH 140 may be coupled to, for example, a Peripheral Component Interconnect (PCI) bus adhering to a Specification Revision 2.1 bus developed by the PCI Special Interest Group of Portland, Oreg. Thus, in one embodiment, ICH 140 includes PCI bridge 146 that provides an interface to PCI bus 142. PCI bridge 146 provides a data path between processor 102 and peripheral devices. In another embodiment MCH and ICH are integrated together and also include PCI or other device/bridge function. In one embodiment, PCI bus 142 is coupled with audio device 150 and disk drive 155. However, other and/or different devices may be coupled to PCI bus 142. In addition, processor 102 and MCH 110 could be combined to form a single chip.

In addition, other and/or different peripheral devices may also be coupled to ICH 140 in various embodiments. For example, such peripheral devices may include integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Moreover, electronic system 100 can receive electrical power from one or more of the following sources for its operation: a battery, alternating current (AC) outlet (e.g., through a transformer and/or adaptor), automotive power supplies, airplane power supplies, and the like.

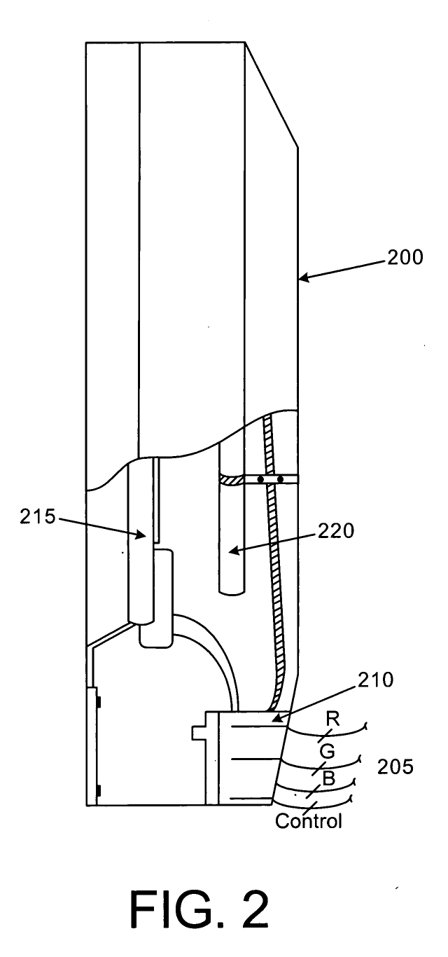

FIG. 2 illustrates a cross-section of one embodiment of a flat-panel display monitor. In one embodiment, display signals 205 generated by a display device, such as a graphics accelerator, are interpreted by flat-panel monitor control device 210 and subsequently displayed by enabling pixels within flat-panel monitor screen 215. The pixels are illuminated by backlight 220, the brightness of which effects the brightness of the pixels and therefore the brightness of the displayed image.

As described in greater detail herein, the brightness of backlight 220 can be adjusted to provide more efficient power usage, to provide appropriate brightness based on ambient conditions, and/or to compensate for image intensity changes. The color intensity values for the pixels can also be adjusted based on ambient conditions and/or backlight intensity.

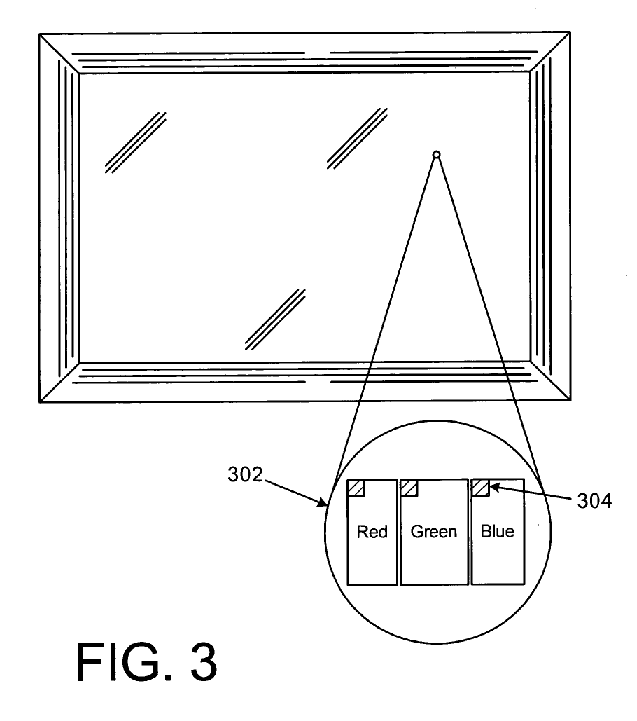

FIG. 3 illustrates a group of pixels within a flat-panel monitor screen. In one embodiment, the pixels are formed using thin film transistor (TFT) technology, and each pixel is composed of three sub-pixels 302 that, when enabled, cause a red, green, and blue (RGB) color to be displayed, respectively. Each sub-pixel is controlled by a TFT (e.g., 304). A TFT enables light from a display backlight to pass through a sub-pixel, thereby illuminating the sub-pixel to a particular color. Each sub-pixel color may vary according to a combination of bits representing the sub-pixel. The number of bits representing a sub-pixel determines the number of colors, or color depth, that may be displayed by a sub-pixel. Sub-pixel coloring is known in the art and any appropriate technique for providing sub-pixel coloring can be used.

A brighter or dimmer luminance of a color being displayed by a pixel can be achieved by scaling the value representing each sub-pixel color (red, green, and blue, respectively) within the pixel. The particular values used to represent different colors depends upon the color-coding scheme, or color space, used by the particular display device. By modifying the color luminance of the sub-pixels (by scaling the values representing sub-pixel colors) the perceived brightness of the display image may be modified on a pixel-by-pixel basis.

In one embodiment, color luminance is adjusted via modification of the color look-up table (gamma table) inside the graphics controller, which adjust the sub-pixel colors prior to being sent to the display device. In another embodiment the pixel may be adjusted directly without using a look-up table for example by converting the pixel to a color-space in which the pixel color luminance is expressed, and then adjusting that term given the desired change in luminance, prior to passing the pixel to the display device.

Furthermore, by modifying the color shade of each pixel, the amount of backlight necessary to create a display image of a particular display image quality can be modified accordingly. For example, increased brightness caused by manipulation of the color look-up table to provide opportunity to decrease backlight intensity and therefore a reduction in power consumption.

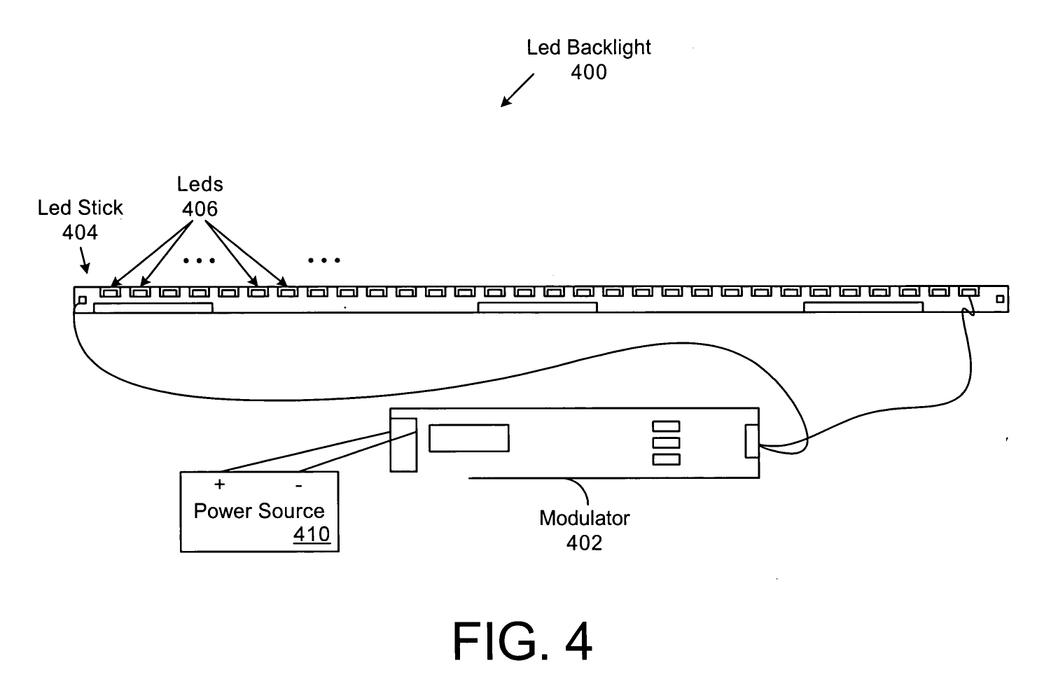

FIG. 4 illustrates one embodiment of a light emitting diode (LED) backlight for a notebook computer display system. In one embodiment, LED backlight 400 includes modulator 402, and LED stick 404, which includes LEDs 406. For example, LED stick 404 can include any number of LEDs. In one embodiment, LEDs 406 are white LEDs; however, LEDs 406 can be, for example, blue or ultraviolet LEDs. Modulator 402 receives power from power source 410, which can be a battery (e.g., a 12 Volt battery) or other power source. Modulator 402 controls the intensity of backlighting provided by LEDs 406.

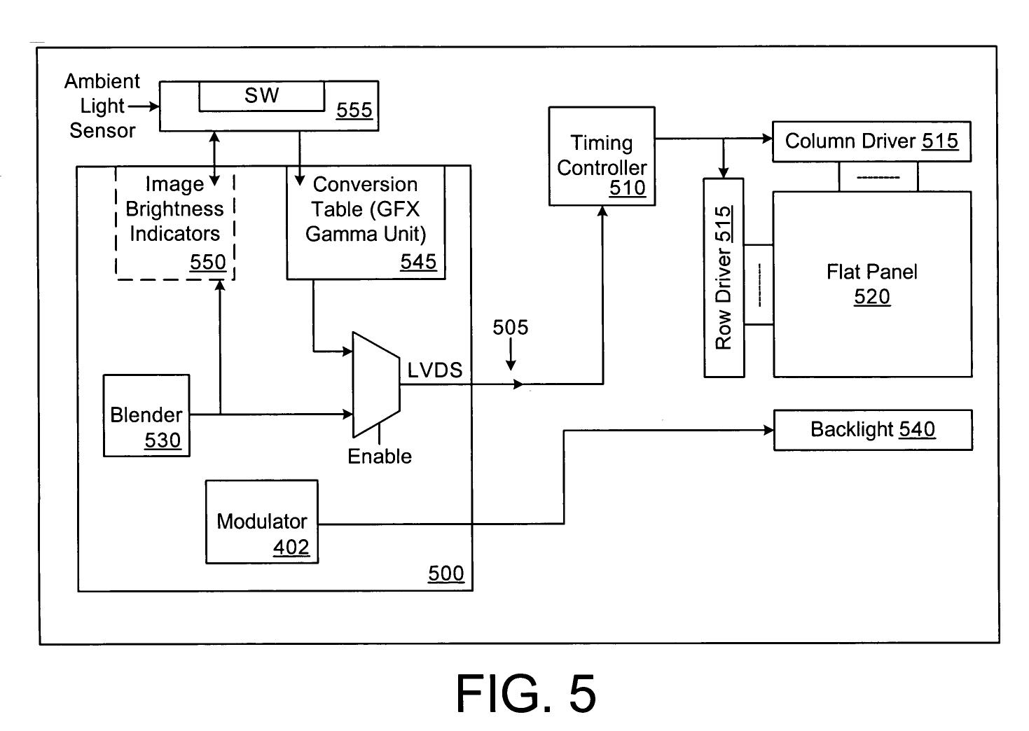

FIG. 5 illustrates one embodiment of a display system. Display device 500 generates display signals 505, which enable timing controller 510 to activate appropriate column and row drivers 515 to display an image on flat-panel display monitor 520. Flat-panel monitor 520 may be an LCD, plasma, or any type of flat-panel display.

In one embodiment, display device 500 includes modulator 402, blender unit 530, and conversion table (also referred to as a gamma unit) 545. As described above, modulator 402 controls luminance (brightness) of backlight 540. In one embodiment, modulator 402 may include, or be coupled with, an integrated inverter, for example, an industry Siemens flat panel display technology (I-SFT) inverter.

In an embodiment, blender unit 530 creates an image to be displayed on the display monitor by combining a display image with other display data, such as texture(s), lighting, and/or filtering data. These techniques are known in the art. In one embodiment, the display image from blender unit 530 and the output of gamma unit 545 can be combined generate display signals 505, which are transmitted to timing controller 510, as discussed above.

Graphics gamma unit 545 effects the brightness of an image to be displayed by scaling each sub-pixel color. In one embodiment, graphics gamma unit 545 can be programmed to scale the sub-pixel color on a per-pixel basis in order to achieve greater brightness in some areas of the display image, while reducing the brightness in other areas of the display image.

In one embodiment, display image brightness indicators 550 include data indicating image brightness determined by monitoring and accumulating pixel color within the display image. The display image brightness indicators can then indicate to control logic 555 the brightness of certain features within the display image, such as display image character and background brightness. Control logic 555 can be implemented as hardware, software or a combination of hardware and software.

In one embodiment, control logic 555 receives signals from an ambient light sensor and determines the environment the display is being used in to, for example, adjust the display characteristics (such as brightness and/or contrast) accordingly. In one embodiment, control logic 555 generates a histogram of pixel brightness values that are stored in a set of registers. Under certain conditions, one or more of the registers can become saturated, which can lead to image degradation and/or less than optimal dynamic backlight adjustments.

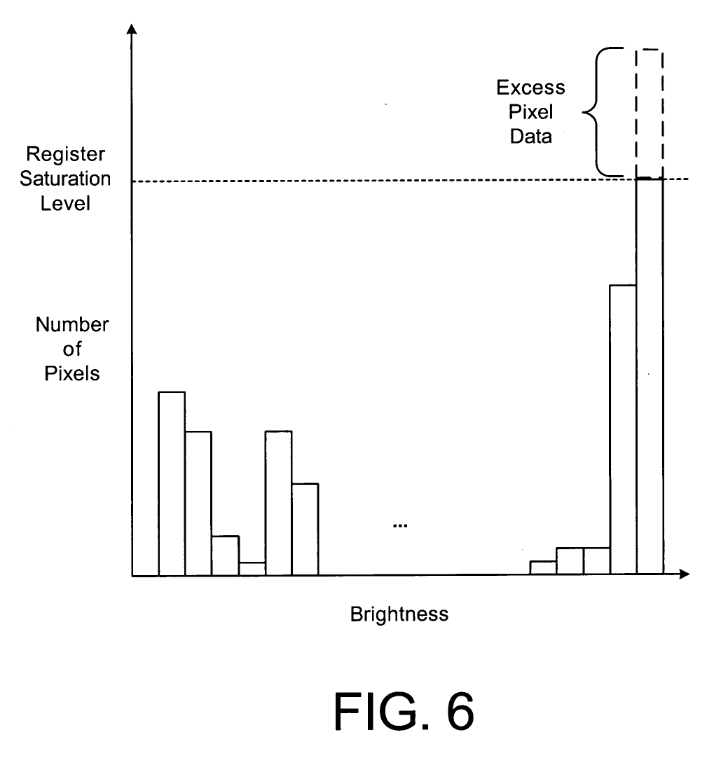

FIG. 6 is a conceptual illustration of a histogram in which a brightness value causes register saturation. The horizontal axis of FIG. 6 corresponds to brightness values for the pixels of an image to be displayed. For example, if 256 brightness values are supported, the brightness axis can have values 0-255, where 0 indicates no brightness (i.e., the corresponding pixel receives no light) and 255 indicates maximum brightness for the pixel. The vertical axis indicates the number of pixels in the image to be displayed that correspond to the individual brightness values.

In one embodiment, a set of registers are used to store computed brightness values. For example, 256 registers can be used to store the number of pixels in a picture having the respective brightness values. A different number of registers can also be used. Because the total number of pixels in the image to be displayed exceeds the capacity of the register, the exact number of pixels having a brightness corresponding to a saturated register is unknown.

As described above, the overall brightness of an image can be dynamically adjusted through modification of the color look-up table. However, without the ability to identify the overall brightness of the image to be displayed, image and/or corresponding backlight intensity adjustments may not be optimal. In one embodiment, when a register becomes saturated, the “excess pixel data” is shifted to a non-saturated register corresponding to a similar brightness.

Pixel data can be accumulated by, for example, incrementing a value stored in a brightness register when a pixel having the corresponding brightness is processed. When the register reaches the saturation threshold, when subsequent pixels of the saturated brightness are processed, a neighboring brightness register can be incremented. Other techniques for reassigning excess pixel data can also be used.

In the example that follows (FIGS. 6-8), excess pixel data is shifted to a closest non-saturated register having a lower brightness value. In alternate embodiments, the excess pixel data can be reassigned in a different manner. For example, the excess pixel data can be shifted to registers corresponding to brightness levels two or more levels away from the saturated register and/or the pixel data can be shifted to registers corresponding to a higher brightness value.

In FIG. 6, the dashed area above the “register saturation level” line indicates the magnitude of the excess pixel data. However, during operation the control logic cannot evaluate the magnitude of the excess pixel data because the data cannot be stored in a register that has become saturated. Therefore, the excess pixel data as indicated by the dashed area above the register saturation level line is “shifted” to a non-saturated register.

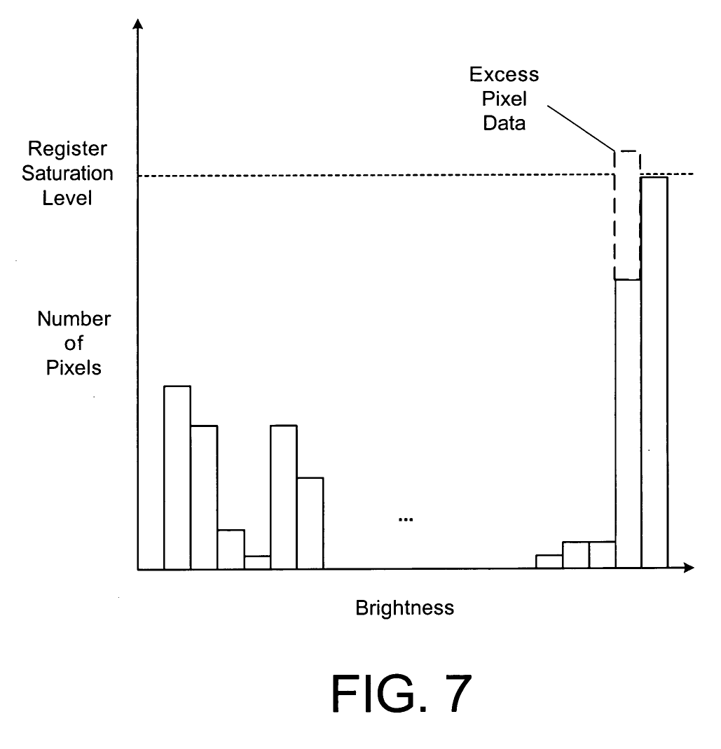

FIG. 7 is a conceptual illustration of the histogram of FIG. 6 in which excess pixel data has been reassigned to a neighboring non-saturated register. In the current example, the shifted excess pixel data also saturates the non-saturated register. In another embodiment, the excess pixel data is shifted to a nearest non-saturated register whether or not the shifting will saturate the target register. In an alternate embodiment, the excess pixel data is shifted to a non-saturated register that will not be saturated by the excess pixel data.

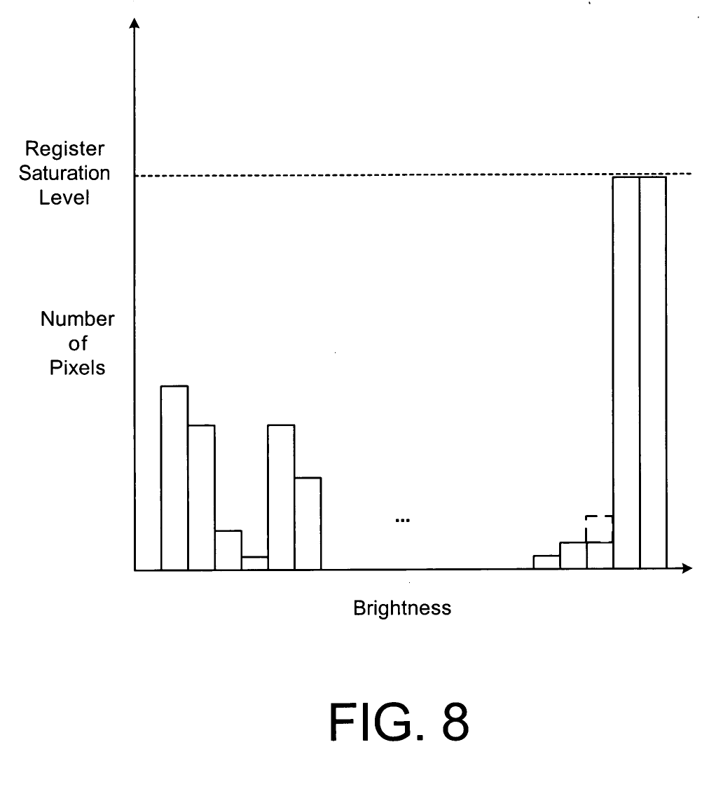

In one embodiment, when the excess pixel data saturates the previously non-saturated register to which the data are shifted, the excess pixel data from the newly saturated register is shifted to a non-saturated register. FIG. 8 is a conceptual illustration of the histogram of FIG. 7 in which excess pixel data has been reassigned to a neighboring non-saturated register. When all, or a sufficient portion of, the excess pixel data has been reassigned, the control logic can perform image brightness and backlight intensity compensation.

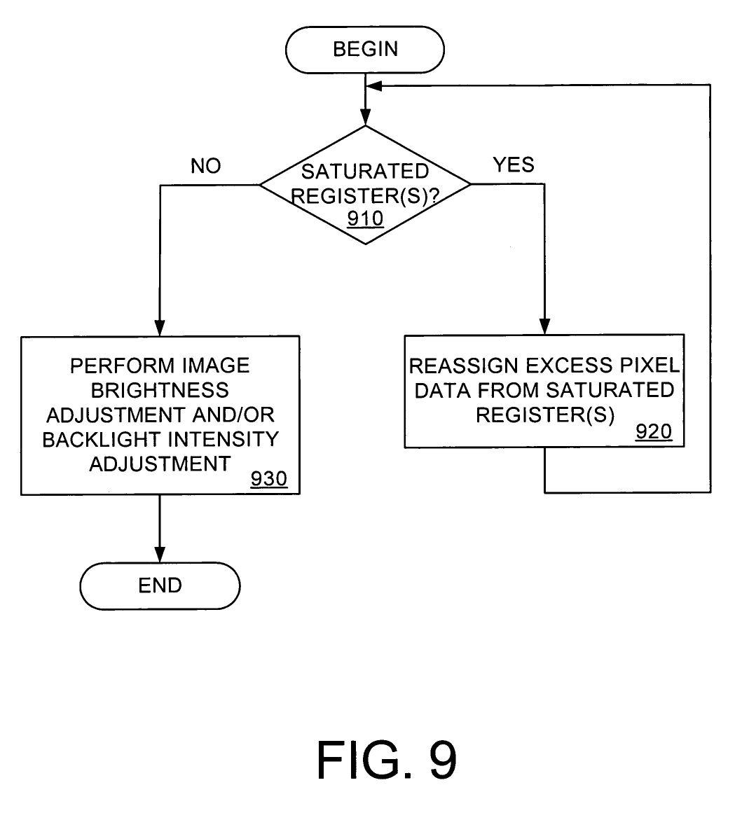

FIG. 9 is a flow diagram of one embodiment of reassignment of excess pixel data. Control logic determines whether any of the brightness registers are saturated, 910. The control logic can be implemented as hardware, software or a combination of hardware and software. In the example above, saturation of a register is described as a number of pixels of a brightness corresponding to a register exceeding the number of pixels that can be counted by the register. However, any threshold value can be used to identify a saturated register.

If one or more registers are saturated, the excess pixel data corresponding to the saturated register(s) is/are reassigned using one of the techniques described above, 920. In one embodiment, reassignment is performed as many times as is necessary to achieve a state in which none of the registers is saturated. In an alternate embodiment, reassignment can be performed a predetermined number of times.

When none of the registers are saturated, image brightness adjustment and/or corresponding backlight intensity adjustment can be performed, 930. In one embodiment, using the brightness data from a histogram stored in the registers, the overall brightness of the image to be displayed is determined. The brightness of one or more pixels in the image can be increased with a corresponding decrease in backlight intensity, which provides better battery life than in a non-adjusted image. In one embodiment, an ambient light senor is used to determine a desired brightness level to be provided by the brightness of the image and/or backlight intensity.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. An apparatus comprising:
a set of registers corresponding to computed brightness values to store data indicating a number of pixels of an image having respective computed brightness values, each register having an associated saturation threshold value; and
an image brightness agent communicatively coupled with the set of registers to determine whether a register is saturated and to redistribute computed brightness values to one or more non-saturated registers.

2. The apparatus of claim 1 further comprising a color look-up table coupled with the image brightness agent, the image brightness agent to modify the color look-up table based on computed brightness values stored in the registers.

3. The apparatus of claim 2 wherein the registers store brightness histogram values.

4. The apparatus of claim 2 further comprising a backlight control agent communicatively coupled with the image brightness agent, the backlight control agent to modify backlight brightness based on modifications to the color look-up table.

5. The apparatus of claim 1 wherein one or more of the saturation threshold values comprises a largest number to be stored by the associated register.

6. The apparatus of claim 1 wherein one or more of the saturation threshold values comprises number less than a largest number to be stored by the associated register.

7. The apparatus of claim 1 wherein the image brightness agent comprises a processor executing sequences of instructions.

8. The apparatus of claim 1 wherein the image brightness agent comprises control circuitry communicatively coupled with the set of registers.

9. The apparatus of claim 1 further comprising a backlight control agent communicatively coupled with the set of registers and the image brightness agent, the backlight control agent to control backlight intensity.

10. The apparatus of claim 9 further comprising an ambient light sensor coupled with the image brightness agent to generate an indication of ambient light level.

11. The apparatus of claim 9 wherein the image brightness agent modifies a color look-up table based on the indication of ambient light level.

12. The apparatus of claim 11 further comprising a backlight control agent communicatively coupled with the set of registers and the image brightness agent, the backlight control agent to control backlight intensity in response to modifications to the color look-up table.

13. A method comprising:
storing, in a plurality of registers, an indication of a number of pixels in an image having a computed brightness value corresponding to the respective registers; and
redistributing a subset of computed brightness values corresponding to one or more registers if the computed brightness value for the register exceeds a threshold value.

14. The method of claim 13 further comprising modifying a color look-up table based on values stored in the registers.

15. The method of claim 14 further comprising modifying a display device backlight intensity based on the modifications to the color look-up table.

16. The method of claim 13 wherein the computed brightness values correspond to brightness histogram values.

17. The method of claim 13 wherein the saturation threshold value comprises a largest number to be stored in a register.

18. The method of claim 13 wherein the saturation threshold value comprises a value less than a largest number to be stored in a register.

19. The method of claim 13 further comprising:
receiving ambient light information from an ambient light sensor and modifying a color look-up table based on the ambient light information; and
modifying a display device backlight intensity based on the modifications to the color look-up table.

20. An article comprising a machine-readable medium having stored thereon instruction that, when executed by one or more processors, cause the one or more processors to:
store, in a plurality of registers, an indication of a number of pixels in an image having a computed brightness value corresponding to the respective registers; and
redistribute a subset of computed brightness values corresponding to one or more registers if the computed brightness value for the register exceeds a threshold value.

21. The article of claim 20 further comprising instructions that, when executed, cause the one or more processors to modify a color look-up table based on values stored in the registers.

22. The article of claim 21 further comprising instructions that, when executed, cause the one or more processors to modify a display device backlight intensity based on the modifications to the color look-up table.

23. The article of claim 20 wherein the computed brightness values correspond to brightness histogram values.

24. The article of claim 20 wherein the saturation threshold value comprises a largest number to be stored in a register.

25. The article of claim 20 wherein the saturation threshold value comprises a value less than a largest number to be stored in a register.

26. The article of claim 20 further comprising instructions that, when executed, cause the one or more processors to:
receive ambient light information from an ambient light sensor and modifying a color look-up table based on the ambient light information; and
modify a display device backlight intensity based on the modifications to the color look-up table.

27. A system comprising:
a set of registers corresponding to computed brightness values to store data indicating a number of pixels of an image having respective computed brightness values, each register having an associated saturation threshold value;
an image brightness agent communicatively coupled with the set of registers to determine whether a register is saturated and to redistribute computed brightness values to one or more non-saturated registers; and
a flat panel display device coupled to display the image.

28. The system of claim 27 further comprising a color look-up table coupled with the image brightness agent, the image brightness agent to modify the color look-up table based on computed brightness values stored in the registers.

29. The system of claim 28 wherein the registers store brightness histogram values.

30. The system of claim 28 further comprising a backlight control agent communicatively coupled with the image brightness agent, the backlight control agent to modify backlight brightness based on modifications to the color look-up table.

31. The system of claim 27 wherein one or more of the saturation threshold values comprises a largest number to be stored by the associated register.

32. The system of claim 27 wherein one or more of the saturation threshold values comprises number less than a largest number to be stored by the associated register.

33. The system of claim 27 further comprising a backlight control agent communicatively coupled with the set of registers and the image brightness agent, the backlight control agent to control backlight intensity.

34. The system of claim 33 further comprising an ambient light sensor coupled with the image brightness agent to generate an indication of ambient light level.

35. The system of claim 33 wherein the image brightness agent modifies a color look-up table based on the indication of ambient light level.

36. The system of claim 35 further comprising a backlight control agent communicatively coupled with the set of registers and the image brightness agent, the backlight control agent to control backlight intensity in response to modifications to the color look-up table.

37. A method comprising:
determining an image brightness profile for an image to be displayed on a display device having an adjustable backlight source; and
modifying an intensity of light provided by the adjustable backlight source based on the brightness profile.

38. The method of claim 37 wherein determining the image brightness profile comprises computing a brightness histogram indicating a number of pixels having associated computed brightness values.

39. The method of claim 38 further comprising storing the computed brightness values in a set of registers, wherein a number of pixels in the image to be displayed exceeds a storage capacity of one or more of the registers, and further wherein one or more of the registers has an associated threshold value.

40. The method of claim 39 further comprising redistributing a subset of computed brightness values corresponding to a selected register if a number of computed brightness values to be stored in the selected register exceeds the threshold value for the selected register.

41. The method of claim 37 further comprising modifying a color look-up table based on the brightness profile.

42. An apparatus comprising:
an image brightness agent to analyze pixels of an image to be displayed on a display device having an adjustable backlight source and to generate an image brightness profile; and
a backlight control circuit coupled with the image brightness agent to dynamically adjust an intensity of light provided by the adjustable backlight source based on the image brightness profile.

43. The apparatus of claim 42 further comprising a display device including the adjustable backlight source, wherein the adjustable backlight source is coupled with the backlight control circuit to provide the intensity of light corresponding to signals received from the backlight control circuit.

44. The apparatus of claim 42 wherein the image brightness agent computes a brightness histogram indicating a number of pixels having associated computed brightness values.

45. The apparatus of claim 44 further comprising a set of registers to store computed brightness values corresponding to pixels in the image to be displayed, wherein one or more of the registers has an associated threshold value, and further wherein a storage capacity of one or more of the registers is less than a number of pixels analyzed by the image brightness agent.

46. The apparatus of claim 45 wherein the image brightness agent redistributes a subset of computed brightness values corresponding to a selected register when a number of computed brightness values to be stored in the selected register exceeds the threshold value associated with the selected register.

47. An article comprising a computer-readable medium having stored thereon instructions that, when executed, cause one or more processing devices to:
determine an image brightness profile for an image to be displayed on a display device having an adjustable backlight source; and
modify an intensity of light provided by the adjustable backlight source based on the brightness profile.

48. The article of claim 47 wherein the instructions that cause the one or more processing devices to determine the image brightness profile comprise instructions that, when executed, cause the one or more processing devices to compute a brightness histogram indicating a number of pixels having associated computed brightness values.

49. The article of claim 48 further comprising instructions that, when executed, cause the one or more processing devices to store the computed brightness values in a set of registers, wherein a number of pixels in the image to be displayed exceeds a storage capacity of one or more of the registers, and further wherein one or more of the registers has an associated threshold value.

50. The article of claim 49 further comprising instructions that, when executed, cause the one or more processing devices to redistribute a subset of computed brightness values corresponding to a selected register if a number of computed brightness values to be stored in the selected register exceeds the threshold value for the selected register.

51. The article of claim 47 further comprising instructions that, when executed, cause the one or more processing devices to modify a color look-up table based on the brightness profile.

52. A system comprising:
a flat panel display device having an adjustable backlight source;
an image brightness agent to analyze pixels of an image to be displayed on the display device and to generate an image brightness profile; and
a backlight control circuit coupled with the image brightness agent to dynamically adjust an intensity of light provided by the adjustable backlight source based on the image brightness profile.

53. The system of claim 52 wherein the image brightness agent computes a brightness histogram indicating a number of pixels having associated computed brightness values.

54. The system of claim 53 further comprising a set of registers to store computed brightness values corresponding to pixels in the image to be displayed, wherein one or more of the registers has an associated threshold value, and further wherein a storage capacity of one or more of the registers is less than a number of pixels analyzed by the image brightness agent and further wherein the image brightness agent redistributes a subset of computed brightness values corresponding to a selected register when a number of computed brightness values to be stored in the selected register exceeds the threshold value associated with the selected register.
